(19) United States
(12) Patent Application Publication
(10) Pub. No.: US 2016/0190690 A1
(43) Pub. Date: Jun. 30, 2016

(54) MULTIBAND SLOT ANTENNA SYSTEM AND APPARATUS

(71) Applicant: Vertu Corporation Limited, Hampshire (GB)

(72) Inventors: Baha Badran, Fleet (GB); Zidong Liu, Poole (GB)

(21) Appl. No.: 14/969,908

(22) Filed: Dec. 15, 2015

(30) Foreign Application Priority Data
Dec. 17, 2014 (GB) 1422426.5

(51) Int. Cl. H01Q 5/15; H01Q 1/24; H01Q 1/52

(52) U.S. Cl. CPC H01Q 5/15; H01Q 1/521; H01Q 1/243

(57) ABSTRACT

An apparatus comprises an antenna ground plane; a conductive side element, a first antenna resonating element; a second antenna resonating element; and a slot-based antenna element formed from slot structures between the conductive side element and the conductive housing element. At least two RF switches are loaded with lump loads, located across the slot-based antenna element and dividing the slot-based antenna element to sections. A first antenna resonating element capacitively coupled to the slot-based antenna element, and forming a first antenna operating at a first frequency; the second antenna resonating element capacitively coupled to the slot-based antenna element, and forming a second antenna operating at a second frequency; and wherein the first and the second frequency are configured to be tuned at different frequencies based on a lump load switched by the first and the second RF switches.

### TECHNICAL FIELD

The invention relates to antenna structures, and particularly to multiband internal slot antennas used in mobile apparatuses.

### BACKGROUND ART

Portable apparatuses, such as mobile phones, tablets and personal computers have ever-increasing demand for a high-speed data access. Furthermore, an antenna system of the apparatus may be arranged to operate in a plurality of different operational radio frequency bands and via a plurality of different protocols. For example, the different frequency bands and protocols may include (but are not limited to) Long Term Evolution (LTE) 700 (US) (698.0-716.0 MHz, 728.0-746.0 MHz), LTE 1500 (Japan) (1427.9-1452.9 MHz, 1475.9-1500.9 MHz), LTE 2600 (Europe) (2500-2570 MHz, 2620-2690 MHz), amplitude modulation (AM) radio (0.535-1.705 MHz); frequency modulation (FM) radio (76-108 MHz); Bluetooth (2400-2483.5 MHz); wireless local area network (WLAN) (2400-2483.5 MHz); helical local area network (HLAN) (5150-5850 MHz); global positioning system (GPS) (1570.42-1580.42 MHz); US-Global system for mobile communications (US-GSM) 850 (824-894 MHz); European global system for mobile communications (EGSM) 600 (880-960 MHz); European wideband code division multiple access (EU-WCDMA) 600 (880-960 MHz); personal communications network (PCN/DCS) 1800 (1710-1880 MHz); US wideband code division multiple access (US-WCDMA) 1600 (1850-1990 MHz); wideband code division multiple access (WCDMA) 2100 (Tx: 1920-1980 MHz Rx: 2110-2180 MHz); personal communications service (PCS) 1600 (1850-1990 MHz); ultra wideband (UWB) Lower (3100-4600 MHz); UWB Upper (6000-10600 MHz); digital video broadcasting-handheld (DVB-H) (470-702 MHz); DVB-H US (1670-1675 MHz); digital radio mondiale (DRM) (0.15-30 MHz); worldwide interoperability for microwave access (WiMax) (2300-2400 MHz, 2305-2360 MHz, 2496-2690 MHz, 3300-3400 MHz; 3400-3800 MHz; 5250-5875 MHz); digital audio broadcasting (DAB) (174.928-239.2 MHz, 1452.96-1490.62 MHz); radio frequency identification low frequency (RFID LF) (0125-0.134 MHz); radio frequency identification high frequency (RFID HF) (13.56-13.56 MHz); radio frequency identification ultra-high frequency (RFID UHF) (433 MHz, 865-956 MHz, 2450 MHz).

With the ever-increasing demand on the high-speed data access on the mobile devices, multiband antennas on the devices have been adapted and used in order to be able to provide the required data rate.

Furthermore, further challenges exist when trying to make antennas work well under a metal device casing, especially when the antennas need to have a high isolation and operate in multi bands. Furthermore, the antennas may be placed in an unfavorable location, for example in the side of a mobile phone.

A slot antenna is an antenna type comprising a metal surface, typically a flat plate, with a hole or slot cut out. When the plate is driven as an antenna by a driving frequency, the slot radiates electromagnetic waves. The shape and size of the slot, as well as the driving frequency, determine the radiation distribution pattern.

Slot antennas have been used in radio telecommunications, such as Bluetooth (2.4 GHz) and WLAN (2.4 GHz; 5.2 GHz and 5.8 GHz). The main advantages of slot antennas are low cost, easy integration with other circuits, low profile and small volume. However, they usually operate at a single band. Current multi-band radio telecommunications systems drive a need for multi-band antennas. Separate antennas could be used to facilitate multi-band functionality, but this is inefficient in terms of space usage.

Dual band slot antennas exist that comprise a conductive antenna body in which two parallel slots of different lengths are provided. Additionally, a single micro strip feed having a T-connection is provided, each branch of which feeds a respective slot. The slots are configured to generate different resonant frequencies, thereby facilitating dual-band functionality. However, the provision of dual slots in the conductive antenna body to facilitate the dual-band functionality, and the consequent need for a branched power feed in respect of the dual slots, results in an antenna which is significantly larger than a single-band quarter-wavelength antenna and, as such, is unsuitable for use in some wireless communications applications.

Thus, an antenna system and an apparatus are needed to provide multiband slot antenna operable as an internal antenna of a mobile apparatus with an improved performance and suitable size.

### SUMMARY

According to a first example aspect of the invention there is provided an apparatus, comprising:
an antenna ground plane;
a conductive side element;
a first antenna resonating element;
a second antenna resonating element;
a slot-based antenna element formed from slot structures adjacent to the
conductive side element, wherein the slot structures having slot open ends;
at least two radio-frequency (RF) switches loaded with a plurality of grounded lump loads, the switches located across the slot-based antenna element and dividing the slot-based antenna element to a first section extending from a first slot open end to a first switch, a second section extending from the first switch to a second switch, and a third section extending from the second switch to a second slot open end;

wherein the first antenna resonating element capacitively coupled at least to the first section of the slot-based antenna element, and forming together with the antenna ground plane and the conductive side element a first antenna operating at a first frequency;

the second antenna resonating element capacitively coupled at least to the third section of the slot-based antenna element, and forming together with the antenna ground plane and the conductive side element a second antenna operating at a second frequency; and

wherein the first and the second frequency are configured to be tuned at different frequencies based on a lump load switched by the first and the second radio-frequency (RF) switches.

In an embodiment, the slot-based antenna element being further divided to a fourth section extending from the second slot open end to a slot close end; and

the second antenna resonating element capacitively coupled to the fourth section of the slot-based antenna element, and forming together with the antenna ground plane and the conductive side element a third antenna operating at a third frequency.

In an embodiment, the first switch being connected to a zero-reactance load;

the first antenna resonating element capacitively coupled to the first section of the slot-based antenna element, and forming together with the antenna ground plane and the conductive side element a first antenna operating at a first frequency; and

the second antenna resonating element capacitively coupled to the second and the third sections of the slot-based antenna element, and forming together with the antenna ground plane and the conductive side element a second antenna operating at a second frequency;

wherein the second frequency being configured to be tuned at different frequencies based on a lump load switched by the second radio-frequency (RF) switch.

In an embodiment, the second switch being connected to a zero-reactance load; and

the first antenna resonating element capacitively coupled to the first and the second sections of the slot-based antenna element, and forming together with the antenna ground plane and the conductive side element a first antenna operating at a first frequency;

wherein the first frequency being configured to be tuned at different frequencies based on a lump load switched by the first radio-frequency (RF) switch; and

the second antenna resonating element capacitively coupled to the third and the fourth sections of the slot-based antenna element, and forming together with the antenna ground plane and the conductive side element a second antenna operating at a second and a third frequency.

In an embodiment, coupling between the first and the second antenna resonating element being optimized by changing the reactance of the lump loads.

According to a second example aspect of the invention there is provided an electronic device, comprising:

an antenna ground plane;

a conductive side element;

a first antenna resonating element;

a second antenna resonating element;

a slot-based antenna element formed from slot structures adjacent to the conductive side element, wherein the slot structures having slot open ends;

at least two radio-frequency (RF) switches loaded with a plurality of grounded lump loads, the switches located across the slot-based antenna element and dividing the slot-based antenna element to a first section extending from a first slot open end to a first switch, a second section extending from the first switch to a second switch, and a third section extending from the second switch to a second slot open end;

wherein the first antenna resonating element capacitively coupled at least to the first section of the slot-based antenna element, and forming together with the antenna ground plane and the conductive side element a first antenna operating at a first frequency;
the second antenna resonating element capacitively coupled at least to the third section of the slot-based antenna element, and forming together with the antenna ground plane and the conductive side element a second antenna operating at a second frequency; and

wherein the first and the second frequency are configured to be tuned at different frequencies based on a lump load switched by the first and the second radio-frequency (RF) switches.

In an embodiment, the device further comprises a support element comprising a circuit board, or a body part of the device.

In an embodiment, the device further comprises a housing comprising a conductive housing element connected to the antenna ground plane.

In an embodiment, the conductive housing element comprising elongated conductive housing element configured to provide a part of an external surface of the device.

In an embodiment, the support element is connected to the antenna ground plane.

In an embodiment, the support element is arranged above the antenna ground plane.

In an embodiment, the first and the second antenna resonating elements comprising elongated antenna resonating elements.

In an embodiment, the elongated antenna resonating elements being parallel to each other.

In an embodiment, the elongated antenna resonating elements being parallel to the elongated conductive housing element.

In an embodiment, the first and the second antenna resonating elements being attached to the support element.

In an embodiment, the support element comprising a first feed point for feeding the first antenna resonating element and a second feed point for feeding the second antenna resonating element.

In an embodiment, the first and the second antenna resonating elements being attached to an edge area of the support element.

In an embodiment, the conductive housing element comprising a rail or a side frame of the device made of metal.

In an embodiment, the slot-based antenna element being further divided to a fourth section extending from the second slot open end to a slot close end;

the second antenna resonating element capacitively coupled to the fourth section of the slot-based antenna element, and forming together with the antenna ground plane a third antenna operating at a third frequency; and

a metal back cover being placed above the fourth section of the slot-based antenna element.

In an embodiment, a display, a touch sensor and signal tracks are placed at an inner side of the slot-based antenna element to reduce interference with the slot-based antenna element.

Different non-binding example aspects and embodiments of the present invention have been illustrated in the foregoing. The above embodiments are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

The invention will be described, by way of example only, with reference to the accompanying drawings, in which:

FIG. 1 shows some details of a multiband slot antenna system in which various embodiments of the invention may be applied;

FIG. 2 shows some details of a RF switch with different lump loads in which various embodiments of the invention may be applied;

FIG. 3 presents a schematic view of an antenna resonating element for a multiband slot antenna system, in which various embodiments of the invention may be applied;

FIG. 4 presents a schematic view of an antenna system and apparatus within an electronic device, in which various embodiments of the invention may be applied;

FIG. 5 presents a schematic view of an apparatus electronic device in which various embodiments of the invention may be applied;

FIG. 6 presents an example block diagram of an electronic device in which various embodiments of the invention may be applied;

FIG. 7 shows operations in an apparatus in accordance with an example embodiment of the invention;

FIG. 8 shows some further details of a multiband slot antenna system and an apparatus in which various embodiments of the invention may be applied;

FIG. 9 shows some further details of a radio-frequency (RF) switch with different lump load components in which various embodiments of the invention may be applied;

FIG. 10 shows some further details of a multiband, multi-feed, frequency-reconfigurable slot antenna system and an apparatus in which various embodiments of the invention may be applied; and

FIG. 11 shows some further details of a multiband, multi-feed, frequency-reconfigurable slot antenna system and an apparatus in which various embodiments of the invention may be applied.

### DETAILED DESCRIPTION

In the following description, like numbers denote like elements.

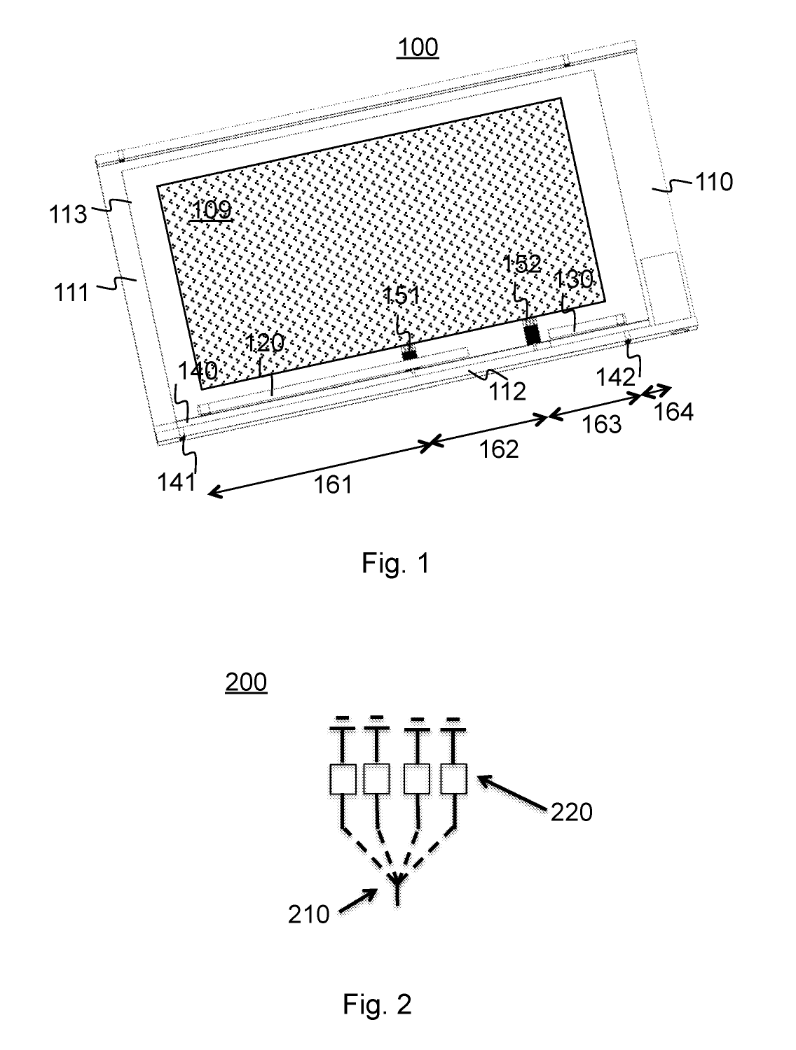

FIG. 1 shows some details of a multiband slot antenna system and an apparatus 100 in which various embodiments of the invention may be applied.

In an embodiment, an apparatus 100 comprises an antenna ground plane 109. The ground plane 109 is illustrated as rectangular element in FIG. 1 but it can be of any shape. The ground plane 109 need not be implemented inside the apparatus 100 but the ground plane may comprise any conductive part of the apparatus 100 or its housing. In FIG. 1, the antenna ground plane 109 may be arranged, for example, as a lowest layer of the support element 113, such as a circuit board.

In an embodiment a conductive housing element 110, 111 may also be configured to serve as the antenna ground plane.

The conductive housing element 110, 111 may be, for example, a metal frame, a conductive chassis or a frame of an electronic device. The apparatus 100 further comprises a first antenna resonating element 120 and a second antenna resonating element 130.

A slot-based antenna element 140 formed from slot structures is located adjacent to a conductive side element 112, wherein the slot structures having slot open ends 141, 142. The slot structures of the slot-based antenna element 140 may be located between the conductive side element 112 and at least one conductive housing element 110, 111 and/or between the conductive side element 112 and the support element 113, such as the circuit board, for example.

Furthermore, at least two radio-frequency (RF) switches 151, 152 loaded with a plurality of grounded lump loads are provided. The switches 151, 152 are located across the slot-based antenna element 140 and dividing the slot-based antenna element to a first section 161 extending from a first slot open end 141 to a first switch 151, a second section 162 extending from the first switch 151 to a second switch 152, and a third section 163 extending from the second switch 152 to a second slot open end 142. Furthermore, a fourth section 164 may be provided extending from the second slot open end 142 to a slot close end. The radio-frequency (RF) switches 151, 152 are connected between the antenna ground plane 109 and the conductive side element 112.

The first antenna resonating element 120 is capacitively coupled at least to the first section 161 of the slot-based antenna element 140, and forming together with the antenna ground plane 109 and the conductive side element 112 a first antenna operating at a first frequency.

The second antenna resonating element 130 is capacitively coupled at least to the third section 163 of the slot-based antenna element 140, and forming together with the antenna ground plane 109 and the conductive side element 112 a second antenna operating at a second frequency.

The first and the second frequency are configured to be tuned at different frequencies based on a lump load switched by the first and the second radio-frequency (RF) switches 151, 152. Thus multiband antenna with tunable frequencies is achieved.

In an embodiment, the second antenna resonating element 130 is capacitively coupled to the fourth section 164 of the slot-based antenna element 140, and forming together with the antenna ground plane 109 and the conductive side element 112 a third antenna operating at a third frequency.

The multiband slot antenna system 100 may further comprise further support elements 113, such as a printed circuit board (PCB), a body part, a chassis, a carrier, a frame or a cover part of an apparatus.

In an embodiment, a plastic carrier may be used for attaching the antennas 120, 130 in a desired position inside the device housing. The plastic carrier may be used also together with the printed circuit board (PCB) to enhance attachment and positioning of the antennas 120, 130.

The first and the second antenna 120, 130 may be attached parallel to a support element 113 over a certain distance.

In an embodiment, exemplary dimensions of different elements may be following. A first antenna element 120 is arranged to be 64 mm in length and a second antenna element 130 is arranged to be 18 mm in length. Slot section 161-164 lengths may vary depending on placement of the RF switches 151-152.

In an embodiment, exemplary dimensions of different slot sections may be following. A first section 161 extending from a first slot open end 141 to a first switch 151 is 32 mm long. A second section 162 extending from the first switch 151 to a second switch 152 is also 32 mm long. However, the first and second sections do not have to be the same length. A third section 163 extending from the second switch 152 to a second slot open end 142 is 14 mm long. A fourth section extending from the second slot open end 142 to a slot close end is 2.5 mm long.

In an embodiment, if placing the RF switch 151 in the middle of the first antenna element 120, and arranging following lump load components to the RF switch 151, following low-band frequencies (LB) are reached, for example, by the first antenna element 120 (low-band).

| LB: | LB band: | lump load: | |
|---|---|---|---|
| B17 | 734-746 MHz | 11 | nH |
| B20 | 791-821 MHz | 6.2 | nH |
| B5 | 869-894 MHz | 2.9 | nH |
| B8 | 925-960 MHz | 0 | Ohm |

FIG. 2 shows some details of a radio-frequency (RF) switch 200 with different lump loads in which various embodiments of the invention may be applied.

In an embodiment, a radio-frequency (RF) switch 200 comprises a switching element 210 configured to switch different lump loads 220 to the antenna ground plane (e.g. ground plane 109 or grounded element 110, 111 of FIG. 1). The lump loads 220 may comprise different reactance loads that can be selectively switched via the switching element 210 to the antenna ground plane.

For example, lump loads 220 may comprise different fixed-value inductors and capacitors. In one embodiment, a number of inductors and capacitors may be coupled in parallel, as is illustrated by inductor and capacitor loads 220. Sufficient inductor and capacitors may be coupled in parallel to provide, for example, 4 or more discrete values. The inductor and capacitors are electrically and individually switched by respective switches in the switching element 210. In one embodiment, diodes with a large intrinsic region between p- and n-doped semiconducting regions, hereafter referred to as PIN diodes, may be utilized to provide the switching function. In a second embodiment, switch circuit 210 is comprised of RF relays, for example.

In an embodiment, the electronic device is configured to control the lump loads of both switches. Thus multiband antenna system may be dynamic in nature and the used frequency bands may be controlled based on service needs within the electronic device.

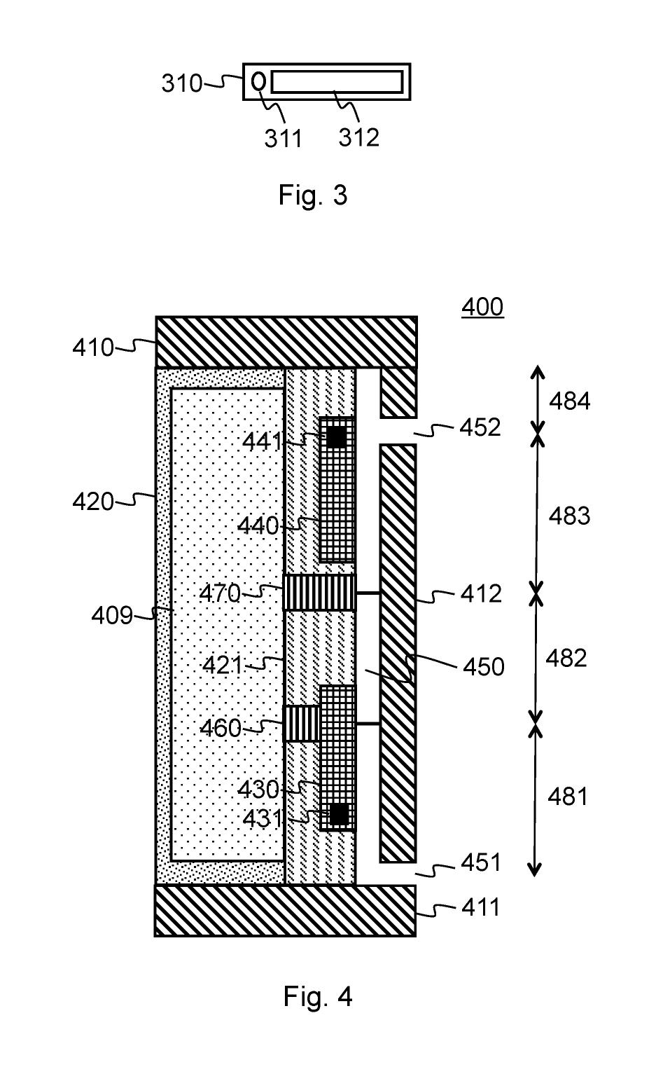

FIG. 3 presents a schematic view of an antenna resonating element for a multiband slot antenna system, in which various embodiments of the invention may be applied. The antenna system may comprise a plurality of antenna resonating elements, as illustrated in FIG. 1.

In an embodiment, an antenna resonating element comprises an elongated antenna resonating element 310 connected to a feed point 311, comprising a radiator 312 configured to resonate in at least one frequency band.

FIG. 4. presents a schematic view of an antenna system and apparatus within an electronic device 400, in which various embodiments of the invention may be applied.

In FIG. 4, only selected parts of the device is shown to clarify the embodiment. Furthermore, relative sizes of the elements do not necessarily correspond to real life.

An electronic device 400 comprises housing parts 409, 410, 411 comprising at least one conductive housing element 409 configured to serve as an antenna ground plane. Comprised by the housing 409-411 may be a support element 420. The support element 420 may be a printed circuit board (PCB), a chassis, a frame, a carrier or a plate, for example. Also the support element 420 may be used as an antenna ground plane, depending on the used material of the support element 420. However, a printed circuit board (PCB) is not necessarily required but replaced, for example, by a carrier, a frame or a plate.

In an embodiment, conductive housing parts 410, 411 are configured to serve as an antenna ground plane 409.

In an embodiment, a plastic carrier 421, such as a plastic chassis, may be used for attachment of resonating elements 430, 440.

In an embodiment, on the support element 420 there is a first antenna resonating element 430 comprising a first antenna feed 431. Also a second antenna resonating element 440 comprising a second antenna feed 441 is arranged on the support element 420. The support element 420 is of non-conductive material to enable improved antenna performance.

No matter housing elements 409-411 are drawn as separate elements in FIG. 4, they may be combined as well and form only one element or two elements.

In an embodiment, at least one housing element 409 is a conductive housing element.

In an embodiment, housing elements 409-411 form together a conductive housing element.

A slot-based antenna element 450 is formed from slot structures adjacent to a conductive side element 412, wherein the slot structures have slot open ends 451, 452. At least one end of the slot structure may still extend beyond at least one of the slot open ends 451, 452 that is illustrated as a closed end slot extending beyond slot open end 452.

In an embodiment, the slot-based antenna element 450 and its slot structures may also be located between the conductive side element 412 and at least one of the conductive housing elements 409, 410, 411.

In an embodiment, the slot-based antenna element 450 and its slot structures may also be located between the conductive side element 412 and the support element 420.

In an embodiment, at least two radio-frequency (RF) switches 460, 470 are arranged across the slot-based antenna element 450 and dividing the slot-based antenna element 450 to a first section 481 extending from a first slot open end 451 to a first switch 460, a second section 482 extending from the first switch 460 to a second switch 470, and a third section 483 extending from the second switch 470 to a second slot open end 452. Furthermore, a fourth section may be arranged and extending from the second slot open end 452 to the end of the slot structure 450. Both switches 460, 470 may be loaded with a plurality of grounded lump loads that can be either individually or in a group connected to the ground. As showed in FIG. 4, both switches 460, 470 are also connected over the slot 450 to the conductive element 412.

In an embodiment, the first antenna resonating element 430 is capacitively coupled at least to the first section 481 of the slot-based antenna element 450, and forming together with the antenna ground plane 409 and the conductive side element 412 a first antenna operating at a first frequency.

In an embodiment, the second antenna resonating element 440 is capacitively coupled at least to the third section 483 of the slot-based antenna element 450, and forming together with the antenna ground plane 409 and the conductive side element 412 a second antenna operating at a second frequency.

In an embodiment, the first and the second frequency are configured to be tuned at different frequencies based on a lump load switched by the first and the second radio-frequency (RF) switches 460, 470.

The first and the second antenna elements 430, 440 are attached parallel to the support element 420. In the embodiment of FIG. 4, the first antenna element 430 is located in the right end of the support element 420 and lower compared to the second element 440. The second antenna element is located also in the right end of the support element 420 and upper compared to the first element 430. Alternatively, the left end of the support element 420 may be used and upper and lower positions may be changed. When placing the antennas elements as far away from each other as possible in the support element 420, spatial diversity may be improved.

An elongated conductive side element 412 is connected to a ground level 409, 410, 411 via the RF switches 460, 470. The elongated conductive element 412 may be parallel to the first and the second elongated antenna elements 430, 440. A display, a touch sensor and its signal tracks (not shown) of the device 400 may be placed at the inner side of the slots 450 so that they do not interfere with the slot 450. The antenna system may comprise a plurality of support elements 420. For example, antenna elements 430, 440 may be attached to a printed circuit board of the device 400 and the conductive side element 412 may be attached to a cover part of the device 400, for example.

In an embodiment, a plurality of elongated conductive elements 410-411 may be comprised in the system.

In an embodiment, the first and the second feed point 431, 441 of the first and the second antenna element 430, 440, may be located in a first end of the first and the second elongated antenna element, respectively.

In an embodiment, the elongated conductive side element 412 may comprise a rail or frame member made of a metal and providing external surface of the device 400, such as a side frame.

Antenna radiator type may be a quarter wavelength radiator, e.g. inverted L antenna (ILA), monopole, planar inverted F antenna (PIFA), inverted F antenna (IFA), for example.

In an embodiment, a feed of a quarter wavelength radiator is placed between the ground plane and one end of the radiator. The voltage is a minimum at one end of the radiator, which is connected with the feed, and a maximum at another end.

Two antenna elements 430, 440 may be placed at the same edge area of a printed circuit board (PCB) 420 respectively. Feeding points 431, 441 for each antenna element may be located on the same side of the apparatus printed circuit board (PCB) 420. The antenna radiators may be on ground, off ground or partially on ground.

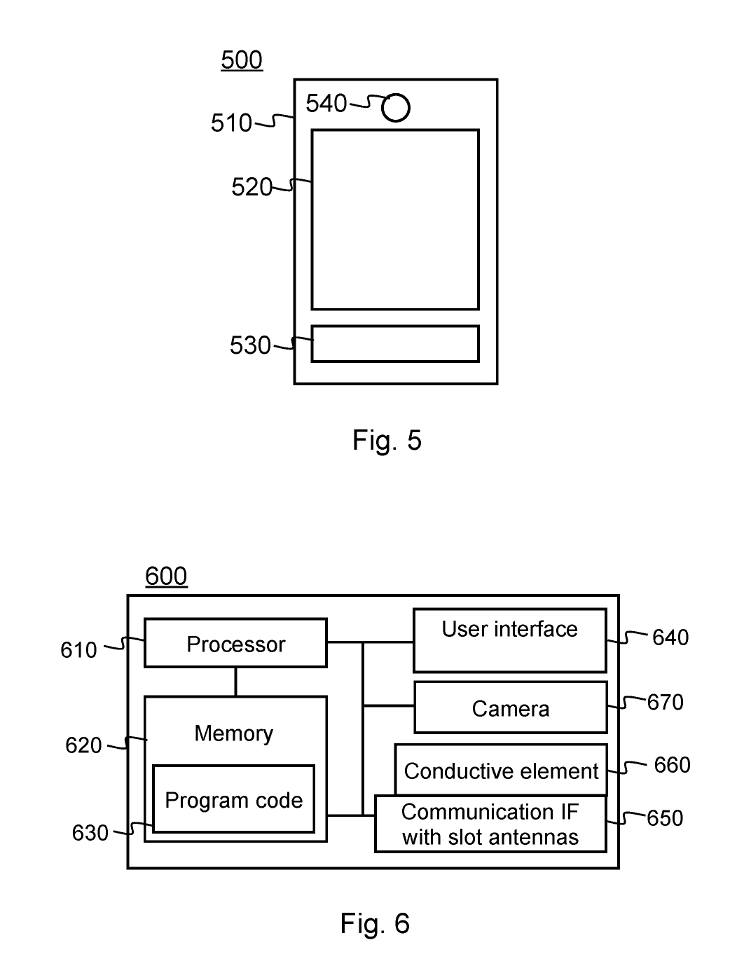

FIG. 5 presents a schematic view of an electronic device 500 in which various embodiments of the invention may be applied.

In an embodiment, the device 500 may comprise a mobile phone, a smart phone, a tablet, a laptop or any other portable apparatus. The device comprises at least one cover part 510 for providing protection to the components of the device 500 and creating desired outlook and outer design for the device 500. The cover part 510 may comprise several separate cover parts, such as front and rear covers and a side frame. The device 500 further comprises user interface 520, 530 comprising at least one display 520. The display 520 may be a touch-sensitive display for detecting user gestures and providing feedback for the device 500. The device 500 may also comprise a user input device 530, such as a keypad or a touchpad, for example. Furthermore, the device 500 may comprise a camera 540. No matter the described elements 510, 520, 530, 540 are shown on the same side of the device 500, they can be located on any side of the device 500.

In an embodiment, at least one of the device elements 510, 520, 530, 540 comprises a conductive element, such as metal rail or sheet, for example. The cover part 510 may comprise a metallic element, such as metal coating, to provide good-looking, strong and scratch resistant surface for the device. The display 520 may comprise a metallic element, such as a display frame or layer, to provide strong body for the display. The user input device may comprise a metallic element, similarly as the display, in case of a touchpad, and similarly as the cover part for the keypad frame in case of a traditional keypad. The camera 540 may comprise an optical element, such as protective cover or body, for example.

In an embodiment, the cover part 510 comprises a conductive side element (e.g. 112 of FIG. 1, or 412 of FIG. 4).

In an embodiment, the cover part 510 may further comprise a conductive element (e.g. 110, 111 of FIG. 1 or 410, 411 of FIG. 4).

The cover part 510 may comprise a casing for a portable communication device for receiving an engine or the multiband slot antenna system of FIGS. 1-4 for operation of the device, the casing comprising: a surface layer as a metallic conductive element, mounted on a defined area of a housing defining, along with the surface layer, at least one layer for the housing; and means for engaging the exposed areas of the substrate with the housing. The metallic layer may also be adhered to the substrate. The adherent may be a UV curing adhesive, for example.

In embodiments of the invention the metallic layer may provide an operating face of the device. This gives a design engineer far greater freedom to design a device with a desirable appearance. The operating face may be provided with a user input element 530, for example a key, or an array of such elements. The casing may be a conventional one-part casing or a clamshell, or other two or more part arrangement, where the user input elements 530 or keys may be located on a different face to a display 520.

FIG. 6 presents an example block diagram of an electronic device 600 in which various embodiments of the invention may be applied. The device 600 may be a user equipment (UE), user device or apparatus, such as a mobile terminal, a smart phone, a personal digital assistant (FDA), a laptop, a tablet or other communication device.

The general structure of the device 600 comprises a user interface 640, a communication interface 650 including at least two elongated antenna elements attached parallel, a processor 610, a camera 670, and a memory 620 coupled to the processor 610. The device 600 further comprises software 630 stored in the memory 620 and operable to be loaded into and executed in the processor 610. The software 630 may comprise one or more software modules and can be in the form of a computer program product. The device 600 further comprises a conductive side element 660 arranged to a housing of the device 600. The conductive side element 660 may also be integrated to another element of the device 600, for example to a cover part, a body part, a circuit board, the user interface 640, or the camera 670.

The processor 610 may be, e.g. a central processing unit (CPU), a microprocessor, a digital signal processor (DSP), a graphics processing unit, or the like. FIG. 6 shows one processor 610, but the device 600 may comprise a plurality of processors.

The memory 620 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The device 600 may comprise a plurality of memories. The memory 620 may be constructed as a part of the device 600 or it may be inserted into a slot, port, or the like of the device 600 by a user. The memory 620 may serve the sole purpose of storing data, or it may be constructed as a part of a device serving other purposes, such as processing data and controlling the lump loads of the RF switches, for example.

The user interface 640 may comprise circuitry for receiving input from a user of the device 600, e.g., via a keyboard, graphical user interface shown on the display of the user device 600, speech recognition circuitry, or an accessory device, such as a headset, and for providing output to the user via, e.g., a graphical user interface or a loudspeaker. The display of the user interface 640 may comprise a touch-sensitive display.

The communication interface module 650 implements at least part of radio transmission. The communication interface module 650 may comprise, e.g., a wireless interface module. The wireless interface may comprise such as near field communication (NFC), a WLAN. Bluetooth, infrared (IR), radio frequency identification (RF ID), GSM/GPRS, CDMA, WCDMA, or LTE (Long Term Evolution) radio module. The communication interface module 650 may be integrated into the user device 600, or into an adapter, card or the like that may be inserted into a suitable slot or port of the device 600. The communication interface module 650 may support one radio interface technology or a plurality of technologies. The device 600 may comprise a plurality of communication interface modules 650. The communication interface module 650 comprises an antenna ground plane, a first antenna resonating element; a second antenna resonating element; a slot-based antenna element formed from slot structures adjacent to the conductive side element 660, wherein the slot structures having slot open ends. The module 650 further comprises at least two radio-frequency (RF) switches loaded with a plurality of grounded lump loads, the switches located across the slot-based antenna element and dividing the slot-based antenna element to a first section extending from a first slot open end to a first switch, a second section extending from the first switch to a second switch, and a third section extending from the second switch to a second slot open end. The first antenna resonating element is capacitively coupled at least to the first section of the slot-based antenna element, and forming together with the antenna ground plane and the conductive side element 660 a first antenna operating at a first frequency. The second antenna resonating element capacitively coupled at least to the third section of the slot-based antenna element, and forming together with the antenna ground plane and the conductive side element 660 a second antenna operating at a second frequency. The first and the second frequency are configured to be tuned at different frequencies based on a lump load switched by the first and the second radio-frequency (RF) switches. Controlling of the switches to select lump loads can be done using the processor 610, the memory 620 and the program code 630. Thus, different slot sections may be tuned, and furthermore, the antenna system of the device 600 may be tuned to operate at different frequencies by changing the lump loads of the radio-frequency (RF) switches. Performance and inter-operability of the device 600 in different frequencies and systems are thus improved.

A skilled person appreciates that in addition to the elements shown in FIG. 6, the device 600 may comprise other elements, such as microphones, displays, as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like. Additionally, the device 600 may comprise a disposable or rechargeable battery (not shown) for powering when external power if external power supply is not available. Furthermore, not all elements of FIG. 6 are mandatory to be implemented within the device 600, such as the camera 670.

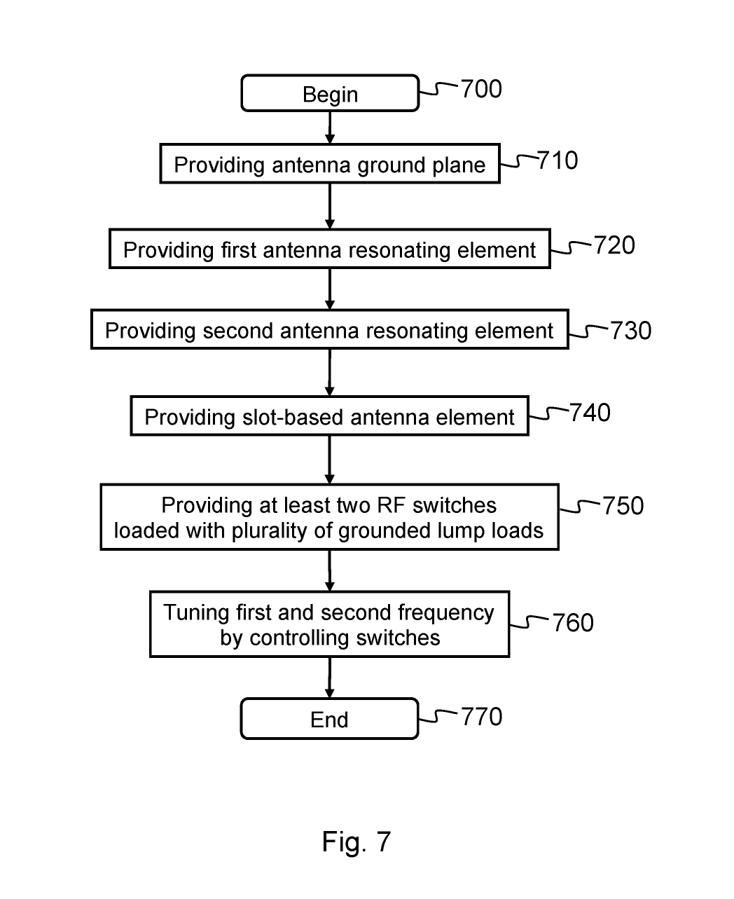

FIG. 7 shows operations in a device in accordance with an example embodiment of the invention.

In step 700, a method for providing a multiband slot antenna system, apparatus and device is started. In step 710, an antenna ground plane is provided. In step 720, a first antenna resonating element is provided. In step 730, a second antenna resonating element is provided. In step 740, a slot-based antenna element is provided to form from slot structures adjacent to the conductive side element, wherein the slot structures having slot open ends. In step 750, at least two radio-frequency (RF) switches are provided that are loaded with a plurality of grounded lump loads, the switches are located across the slot-based antenna element and dividing the slot-based antenna element to a first section extending from a first slot open end to a first switch, a second section extending from the first switch to a second switch, and a third section extending from the second switch to a second slot open end.

The first antenna resonating element is capacitively coupled at least to the first section of the slot-based antenna element, and forming together with the antenna ground plane and the conductive side element a first antenna operating at a first frequency. The second antenna resonating element is capacitively coupled at least to the third section of the slot-based antenna element, and forming together with the antenna ground plane and the conductive side element a second antenna operating at a second frequency.

In step 760, the first and the second frequency are configured to be tuned at different frequencies based on a lump load switched by the first and the second radio-frequency (RF) switches. In step 770, the method ends.

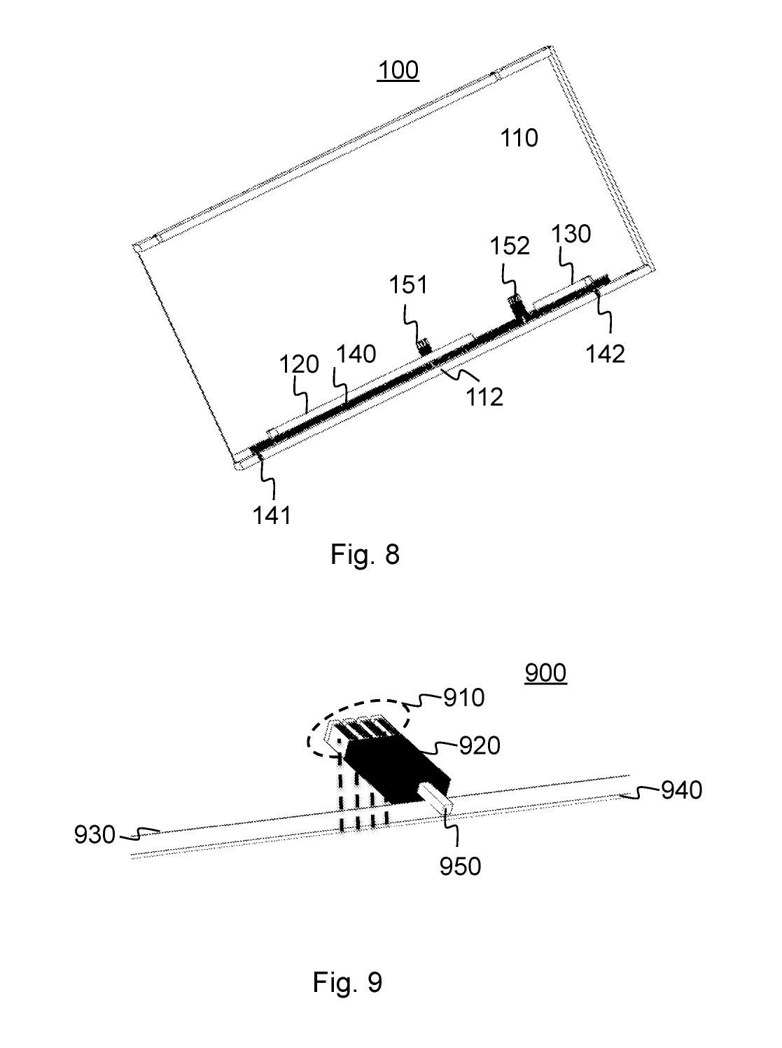

FIG. 8 shows some further details of a multiband slot antenna system and an apparatus 100 in which various embodiments of the invention may be applied.

In an embodiment, an apparatus 100 comprises a conductive housing element 110 configured to serve as an antenna ground plane. The conductive house element may be, for example, a metal frame, or a conductive chassis of an electronic device. The apparatus 100 further comprises a first antenna resonating element 120 and a second antenna resonating element 130.

A slot-based antenna element 140 formed from slot structures is located adjacent to an elongated conductive side element 112, wherein the slot structures having slot open ends 141, 142.

Furthermore, at least two radio-frequency (RF) switches 151, 152 loaded with a plurality of grounded lump loads are provided. The switches 151, 152 are located across the slot-based antenna element 140 and dividing the slot-based antenna element to different sections, as illustrated in FIG. 1.

The first antenna resonating element 120 is capacitively coupled at least to the first section of the slot-based antenna element 140, and forming together with the conductive housing element 110 and the conductive side element 112 a first antenna operating at a first frequency.

The second antenna resonating element 130 is capacitively coupled at least to the third section of the slot-based antenna element 140, and forming together with the conductive housing element 110 and the conductive side element 112 a second antenna operating at a second frequency.

The first and the second frequency are configured to be tuned at different frequencies based on a lump load switched by the first and the second radio-frequency (RF) switches 151, 152. Thus multiband antenna with tunable frequencies is achieved.

In an embodiment, the second antenna resonating element 130 is capacitively coupled to the fourth section of the slot-based antenna element 140, and forming together with the antenna ground plane 110, a third antenna operating at a third frequency.

FIG. 9 shows some further details of a radio-frequency (RF) switch 900 with different lump load components 910 in which various embodiments of the invention may be applied.

In an embodiment, a radio-frequency (RF) switch 900 comprises a switching element 920 configured to switch different lump loads 910 to ground. The lump loads 910 may comprise different reactance loads that can be selectively switched via the switching element 920 to the ground.

In an embodiment, the radio-frequency (RF) switch 900 is supported by a printed circuit board (PCB) 930, and substrate of it. The PCB 930 may comprise a conductive layer 940, such as a copper layer that is grounded, for example to a metal chassis or a conductive housing of the electronic device.

For example, lump loads 910 may comprise different fixed-value inductors or capacitors. Furthermore, lump loads 910 may comprise short circuit to the grounded copper layer 940.

No matter FIG. 9 presents four lump components 910, the number of the components may vary. First ends of the lump components 910 are connected to the switching element 920 and the second ends of the lump components 910 are connected to the copper layer 940 at the bottom layer through holes (not shown) in the PCB 930.

The radio-frequency (RF) switch 900 further comprises a connection element 950 for connecting the switch 900 to slot based antenna element.

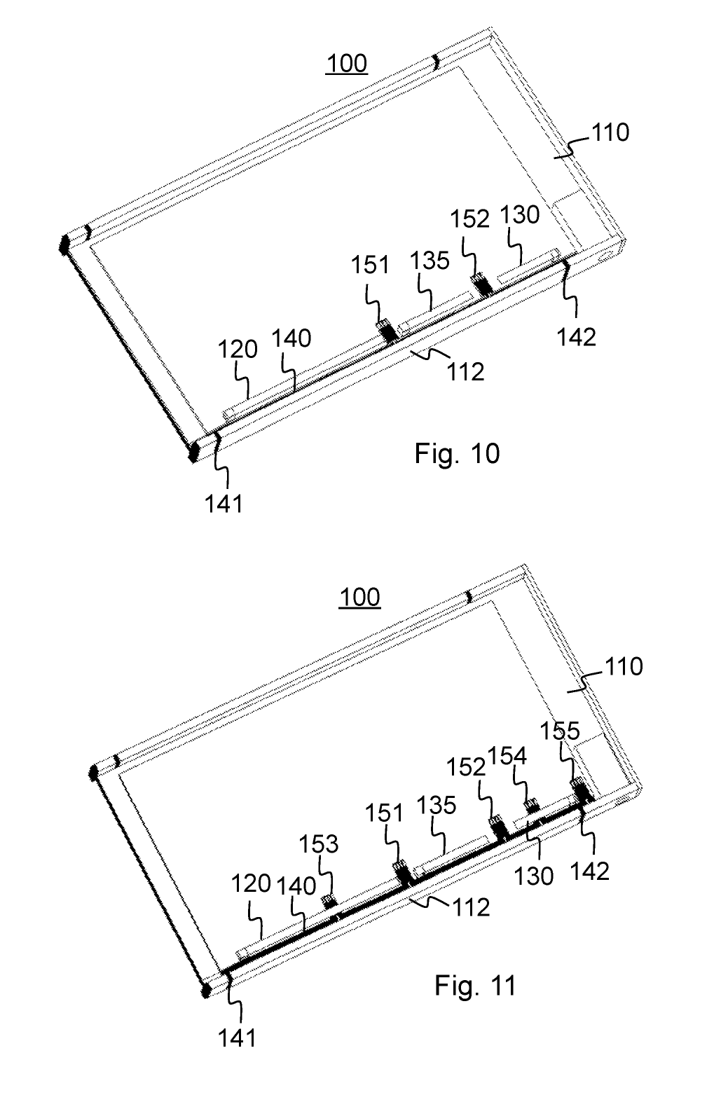

FIG. 10 shows some further details of a multiband, multi-feed, frequency-reconfigurable slot antenna system and an apparatus 100 in which various embodiments of the invention may be applied.

In an embodiment, an apparatus 100 comprises an antenna ground plane 110. The antenna ground plane may be, for example, a conductive housing element 110. The conductive house element may be, for example, a metal frame, or a conductive chassis of an electronic device. The apparatus 100 further comprises a first antenna resonating element 120, a second antenna resonating element 130 and a third antenna resonating element 135.

In an embodiment, antenna ground plane may be implemented as illustrated in FIG. 1 or FIG. 4, wherein the a ground plane was implemented inside the device. Such internal ground plane may be connected to the conductive housing element 110 and used together or separately as the ground plane.

A slot-based antenna element 140 formed from slot structures is located adjacent to an elongated conductive side element 112, wherein the slot structures having slot open ends 141, 142.

Furthermore, at least two radio-frequency (RF) switches 151, 152 loaded with a plurality of grounded lump loads are provided. The switches 151, 152 are located across the slot-based antenna element 140 and dividing the slot-based antenna element to different sections, as illustrated in FIG. 1.

The first antenna resonating element 120 is capacitively coupled at least to the first section of the slot-based antenna element 140, and forming together with the conductive housing element 110 serving as antenna ground plane, and the conductive side element 112, a first antenna operating at a first frequency. The first antenna may be a quarter-wavelength slot antenna.

The second antenna resonating element 130 is capacitively coupled to the third and fourth sections of the slot-based antenna element 140, and forming together with the conductive housing element 110 and the conductive side element 112 a second antenna operating at a second frequency. The second antenna may be a dual-band quarter-wavelength slot antenna.

The third antenna resonating element 135 is capacitively coupled at least to the second section of the slot-based antenna element 140, and forming together with the conductive housing element 110 and the conductive side element 112 a third antenna operating at a third frequency. The third antenna may be a half-wavelength slot antenna.

The first, second and third frequencies are configured to be tuned at different frequencies based on a lump load switched by the first and the second radio-frequency (RF) switches 151, 152. Thus multiband antenna with tunable frequencies is achieved.

In an embodiment, both switches 151, 152 are connected to a zero-reactance lump load.

FIG. 11 shows some further details of a multiband, multi-feed, frequency-reconfigurable slot antenna system and an apparatus 100 in which various embodiments of the invention may be applied.

In an embodiment, an apparatus 100 comprises a conductive housing element 110 configured to serve as an antenna ground plane. The conductive house element may be, for example, a metal frame, or a conductive chassis of an electronic device. The apparatus 100 further comprises a first antenna resonating element 120, a second antenna resonating element 130 and a third antenna resonating element 135.

A slot-based antenna element 140 formed from slot structures is located adjacent to an elongated conductive side element 112, wherein the slot structures having slot open ends 141, 142.

In an embodiment, antenna ground plane may be implemented as illustrated in FIG. 1 or FIG. 4, wherein the a ground plane was implemented inside the device. Such internal ground plane may be connected to the conductive housing element 110 and used together or separately as the ground plane.

Furthermore, at least five radio-frequency (RF) switches 151-155 loaded with a plurality of grounded lump loads are provided. The switches 151-155 are located across the slot-based antenna element 140 and dividing the slot-based antenna element to different sections. A first section extending from a first slot open end 141 to a first switch 151, a second section extending from the first switch 151 to a second switch 152, and a third section extending from the second switch 152 to a second slot open end 142. Furthermore, a fourth section may be provided extending from the second slot open end 142 to a slot close end.

The first antenna resonating element 120 is capacitively coupled at least to the first section of the slot-based antenna element 140, and forming together with the antenna ground plane 110 (e.g. the conductive housing element) and the conductive side element 112 a first antenna operating at a first frequency. The first antenna may be a quarter-wavelength slot antenna.

The second antenna resonating element 130 is capacitively coupled to the third and fourth sections of the slot-based antenna element 140, and forming together with the antenna ground plane 110 (e.g. the conductive housing element) and conductive side element 112 a second antenna operating at a second frequency. The second antenna may be a dual-band quarter-wavelength slot antenna.

The third antenna resonating element 135 is capacitively coupled at least to the second section of the slot-based antenna element 140, and forming together with the antenna ground plane 110 (e.g. the conductive housing element) and the conductive side element 112 a third antenna operating at a third frequency. The third antenna may be a half-wavelength slot antenna.

The first, second and third frequencies are configured to be tuned at different frequencies based on a lump load switched by the radio-frequency (RF) switches 151-155. Thus multiband antenna with tunable frequencies is achieved.

In an embodiment, the switches 151, 152 are connected to a zero-reactance lump load. The switches 153-155 are connected to desired lump loads to tune first, third and fourth sections of the slot 140 and thus also to tune at least the first antenna 120 and the second antenna 130 and their frequencies.

Various embodiments have been presented. It should be appreciated that in this document, words comprise, include and contain are each used as open-ended expressions with no intended exclusivity.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means or in different combinations of embodiments without deviating from the characteristics of the invention.

Furthermore, some of the features of the above-disclosed embodiments of this invention may be used to advantage without the corresponding use of other features. As such, the foregoing description shall be considered as merely illustrative of the principles of the present invention, and not in limitation thereof. Hence, the scope of the invention is only restricted by the appended patent claims.

1. Apparatus, comprising:
an antenna ground plane;
a conductive side element;
a first antenna resonating element;
a second antenna resonating element;
a slot-based antenna element formed from slot structures adjacent to the conductive side element, wherein the slot structures having slot open ends;
at least two radio-frequency (RF) switches loaded with a plurality of grounded lump loads, the switches located across the slot-based antenna element and dividing the slot-based antenna element to a first section extending from a first slot open end to a first switch, a second section extending from the first switch to a second switch, and a third section extending from the second switch to a second slot open end;
wherein the first antenna resonating element capacitively coupled at least to the first section of the slot-based antenna element, and forming together with the antenna ground plane and the conductive side element, a first antenna operating at a first frequency;
the second antenna resonating element capacitively coupled at least to the third section of the slot-based antenna element, and forming together with the antenna ground plane and the conductive side element, a second antenna operating at a second frequency; and
wherein the first and the second frequency are configured to be tuned at different frequencies based on a lump load switched by the first and the second radio-frequency (RF) switches.

2. The apparatus of claim 1, wherein the slot-based antenna element being further divided to a fourth section extending from the second slot open end to a slot close end; and
the second antenna resonating element capacitively coupled to the fourth section of the slot-based antenna element, and forming together with the antenna ground plane a third antenna operating at a third frequency.

3. The apparatus of claim 1, wherein the first switch being connected to a zero-reactance load;
the first antenna resonating element capacitively coupled to the first section of the slot-based antenna element, and forming together with the antenna ground plane and the conductive side element, a first antenna operating at a first frequency; and
the second antenna resonating element capacitively coupled to the second and the third sections of the slot-based antenna element, and forming together with the antenna ground plane and the conductive side element, a second antenna operating at a second frequency;
wherein the second frequency being configured to be tuned at different frequencies based on a lump load switched by the second radio-frequency (RF) switch.

4. The apparatus of claim 1, wherein the second switch being connected to a zero-reactance load; and
the first antenna resonating element capacitively coupled to the first and the second sections of the slot-based antenna element, and forming together with the antenna ground plane and the conductive side element, a first antenna operating at a first frequency;
wherein the first frequency being configured to be tuned at different frequencies based on a lump load switched by the first radio-frequency (RF) switch; and
the second antenna resonating element capacitively coupled to the third and the fourth sections of the slot-based antenna element, and forming together with the antenna ground plane and the conductive side element, a second antenna operating at a second and a third frequency.

5. The apparatus of claim 1, wherein coupling between the first and the second antenna resonating element being optimized by changing the reactance of the lump loads.

6. An electronic device, comprising:
an antenna ground plane;
a conductive side element;
a first antenna resonating element;
a second antenna resonating element;
a slot-based antenna element formed from slot structures adjacent to the conductive side element, wherein the slot structures having slot open ends;
at least two radio-frequency (RF) switches loaded with a plurality of grounded lump loads, the switches located across the slot-based antenna element and dividing the slot-based antenna element to a first section extending from a first slot open end to a first switch, a second section extending from the first switch to a second switch, and a third section extending from the second switch to a second slot open end;
wherein the first antenna resonating element capacitively coupled at least to the first section of the slot-based antenna element, and forming together with the antenna ground plane and the conductive side element, a first antenna operating at a first frequency;
the second antenna resonating element capacitively coupled at least to the third section of the slot-based antenna element, and forming together with the antenna ground plane and the conductive side element, a second antenna operating at a second frequency; and
wherein the first and the second frequency are configured to be tuned at different frequencies based on a lump load switched by the first and the second radio-frequency (RF) switches.

7. The device of claim 6, further comprising a support element comprising a circuit board, or a body part of the device.

8. The device of claim 6, further comprising a housing comprising a conductive housing element connected to the antenna ground plane.

9. The device of claim 6, wherein the conductive side element comprising elongated housing element configured to provide a part of an external surface of the device.

10. The device of claim 7, wherein the support element is connected to the antenna ground plane.

11. The device of claim 7, wherein the support element is arranged above the antenna ground plane.

12. The device of claim 6, wherein the first and the second antenna resonating elements comprising elongated antenna resonating elements.

13. The device of claim 12, wherein the elongated antenna resonating elements being parallel to each other.

14. The device of claim 12, wherein the elongated antenna resonating elements being parallel to the elongated conductive housing element.

15. The device of claim 7, wherein the first and the second antenna resonating elements being attached to the support element.

16. The device of claim 15, wherein the support element comprising a first feed point for feeding the first antenna resonating element and a second feed point for feeding the second antenna resonating element.

17. The device of claim 15, wherein the first and the second antenna resonating elements being attached to an edge area of the support element.

18. The device of claim 8, wherein the conductive housing element comprising a rail, a chassis, a plate or a side frame of the device made of metal.

19. The device of claim 6, wherein the slot-based antenna element being further divided to a fourth section extending from the second slot open end to a slot close end;
the second antenna resonating element capacitively coupled to the fourth section of the slot-based antenna element, and forming together with the antenna ground plane a third antenna operating at a third frequency; and
a metal back cover being placed above the fourth section of the slot-based antenna element.

20. The device of claim 6, wherein a display, a touch sensor and signal tracks are placed at an inner side of the slot-based antenna element to reduce interference with the slot-based antenna element.
